(19) United States
(12) Patent Application Publication
(10) Pub. No.: US 2020/0111165 A1
(43) Pub. Date: Apr. 9, 2020

(54) METHOD AND SYSTEM FOR IMPLEMENTING A CASH MANAGEMENT TOOL

(71) Applicant: JPMorgan Chase Bank, N.A., New York, NY (US)

(72) Inventors: Manish KUMAR, Jersey City, NJ (US); Brij AGARWAL, Glen Ridge, NJ (US); Oliver FURBY, Delaware, OH (US)

(21) Appl. No.: 16/154,005

(22) Filed: Oct. 8, 2018

(51) Int. Cl. G06Q 40/06; G06Q 40/04

(52) U.S. Cl. CPC G06Q 40/06; G06Q 40/04

(57) ABSTRACT

An embodiment of the present invention is directed to a cash management tool. An embodiment of the present invention is directed to providing an ability to view current and projected cash balances to enable investment and portfolio managers to equitize cash to minimize tracking error. The innovative system and method also provides an ability to calculate and raise currency trades to meet benchmark rates.

### FIELD OF THE INVENTION

The present invention generally relates to a cash management tool and more specifically to an automated portfolio management platform for market cap weighted index funds.

### BACKGROUND OF THE INVENTION

Currently, portfolio managers are required to rely heavily on various traditional communications, such as emails, by index providers, risk models and various middle office teams to find their daily investable cash and to execute trades. A primary investment goal of index tracking funds may include keeping a tracking error low/optimized relative to the index. To achieve this goal, portfolio managers seek to invest their cash efficiently and match the currency exposure of their funds to the index currency exposure.

In order to match the currency exposure of index, portfolio managers need to buy equity/bonds and currencies to offset those trades at London close. Since equities and/or bonds are traded at London close, current practice is to trade currencies on T+1 (in active fund management). However, this leaves funds exposed to currency movements overnight.

These and other drawbacks exist.

### SUMMARY OF THE INVENTION

Accordingly, one aspect of the invention is to address one or more of the drawbacks set forth above. According to an embodiment of the present invention, an automated computer implemented system implements an automated cash management tool to manage cash for market cap index. The system comprises: a memory component; an interactive interface that receives one or more user inputs; and an optimizer processor, coupled to the memory component and the interactive interface, the optimizer processor configured to perform the steps comprising: receiving, via an electronic input, a first projected cash that is indexed based; a second projected cash that is books-based and an actual cash measure for a portfolio; identifying equity and fixed income trade at time T−1 for the portfolio; providing, via the interactive interface, one or more open orders for the portfolio; and calculating, responsive to the open orders, one or more currencies to purchase or sell to substantially match a currency exposure of an index in the portfolio at time T to minimize tracking error between the portfolio and the index.

According to another embodiment of the present invention, an automated computer implemented method implements an automated cash management tool to manage cash for market cap index. The method comprises the steps of: receiving, via an electronic input, a first projected cash that is indexed based; a second projected cash that is books-based and an actual cash measure for a portfolio; identifying, via an optimizer processor, equity and fixed income trade at time T−1 for the portfolio; providing, via the interactive interface, one or more open orders; and calculating one or more currencies to purchase or sell to substantially match a currency exposure of an index in the portfolio at time T to minimize tracking error between portfolio and index.

The system may include a specially programmed computer system comprising one or more computer processors, interactive interfaces, electronic storage devices, and networks.

The computer implemented system, method and medium described herein provide unique advantages to entities, organizations, portfolio managers and investors. An embodiment of the present invention provides an innovative automated portfolio management platform for market cap weighted index funds. A traditional cash-management process is manual, labor-intensive and results in built-in delays that lead to tracking error. An embodiment of the present invention delivers real-time views of total available cash, inflows from transfer-agents, and further provides a projection of cash due to corporate actions and unrealized derivatives gain/loss. The innovative cash management tool implements several configurations to predefine a calendar ladder of different instruments that may be equitized to minimize tracking error. Moreover, an embodiment of the present invention manages FX trading in real-time to ensure FX is in-line with index benchmark rates (e.g., London FIX, etc.).

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

In order to facilitate a fuller understanding of the present inventions, reference is now made to the appended drawings. These drawings should not be construed as limiting the present inventions, but are intended to be exemplary only.

FIG. 1 illustrates an exemplary diagram of a cash management system, according to an embodiment of the present invention.

FIG. 2 illustrates a schematic diagram of a system that implements a Cash Management System, according to an exemplary embodiment.

FIG. 3 illustrates an exemplary interactive interface of an Open Orders View, according to an embodiment of the present invention.

FIG. 4 illustrates an exemplary interactive interface of a FX Orders Preview, according to an embodiment of the present invention.

FIG. 5 illustrates an exemplary interactive interface of an ETF/Future Basket View, according to an embodiment of the present invention.

FIG. 6 illustrates an exemplary interactive interface of an Optimization View, according to an embodiment of the present invention.

FIG. 7 illustrates an exemplary interactive interface of an Unequitized Cash View, according to an embodiment of the present invention.

FIG. 8 illustrates an exemplary interactive interface of a Projected Income View, according to an embodiment of the present invention.

FIG. 9 illustrates an exemplary interactive interface of a Cash View, according to an embodiment of the present invention.

### DESCRIPTION OF EMBODIMENTS OF THE INVENTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a cash management tool to provide various functions, including 1) assess current cash balance (with cash component breakdown); 2) directly adjust orders to equitize cash; 3) adjust FX trades to match index benchmark rates; and 4) equitize income due but not received (T+1 and T+2). Other functions and variations may be provided.

The cash management tool may further seek to equitize cash to minimize tracking error.

In accordance with an embodiment of the present invention, cash breakdown may include actual, projected cash and equitizing portfolio.

For example, actual cash breakdown may include available cash from accounting system. Income due but not received (T+2) may refer to any income expected in next 2 days being made available to portfolio managers (PMs) for the investment. As equities generally settle T+2, PMs may then trade based on the money they will receive at T+2. Actual cash breakdown may also refer to ShortTerm/Money Market which may refer to any cash invested in short term that may be liquidated immediately and settles at T+1. Actual cash breakdown may also include non-settle trades (e.g., any trades which are done but not settled yet), collateral (e.g., any collateral posted in the account can be invested) and subs/reds (e.g., any client subs/reds). Subscriptions and Redemptions (subs/reds) refers to an investor receiving shares of the fund (or ETF) in return for their investment in the fund (or an ETF).

Projected Cash may refer to corporate actions based cash, open orders and unrealized gain or less. For corporate actions based cash, an embodiment of the present invention may connect to various index providers (e.g., Morning Star, MSCI, S&P, Russell, etc.) to pull corporate actions and project the cash that is expected to be receive due to corporate actions. For example, this may include cash receivable due to expected merger and acquisition and cash receivable due to expected dividends. Projected Cash may refer to Open Orders, which may include projected cash due to the trades PMs have submitted where the money due to trading is estimated.

An embodiment of the present invention provides an equitizing portfolio feature that suggests ETFs/Future to purchase to equitize cash if a user is unable to buy physicals.

In order to match the currency exposure of index, portfolio managers need to buy equity and/or bonds and currencies needed to offset those trades at London close. Because equities and/or bonds are traded at London closes, the previous practice was to trade currencies on T+1 (in active fund management). However, this leaves funds exposed to currency movements overnight.

An embodiment of the present invention is directed to a cash management tool that facilitates (and/or suggests PMs) to trade estimated FX on T (before London Close) based on the open equity/bonds orders. The cash management tool may suggest currencies needed to settle the equities/bonds trades.

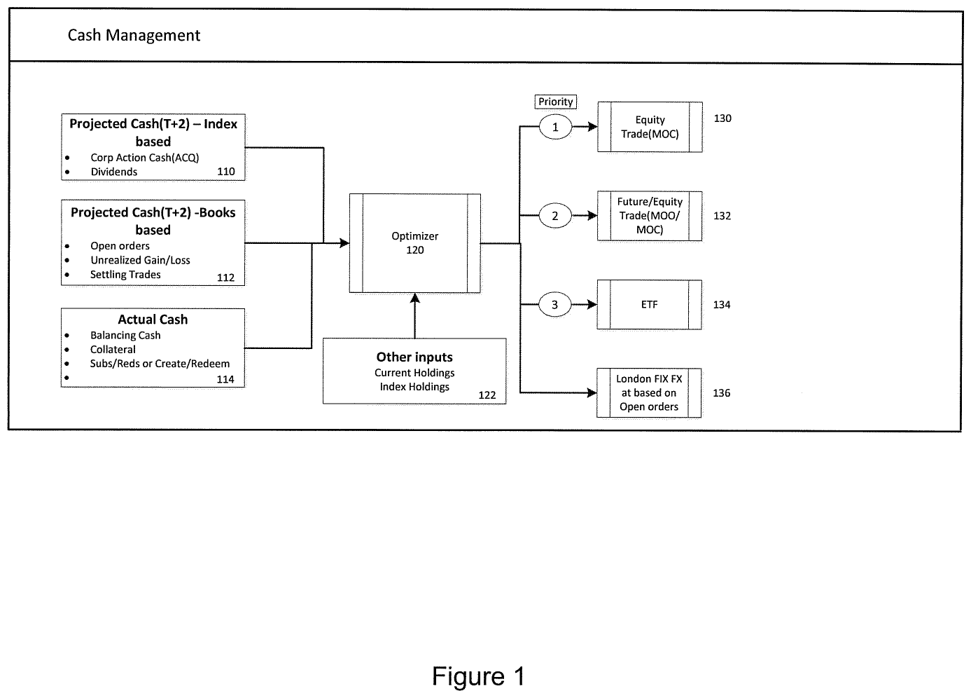

FIG. 1 illustrates an exemplary diagram of a cash management system, according to an embodiment of the present invention. An embodiment of the present invention is directed to providing an ability to view current and projected cash balances to enable Investment managers to equitize cash to minimize tracking error. The innovative system and method also provides an ability to calculate and raise currency trades to meet benchmark rates.

User Functions may include various views of current cash balance, which may include cash component breakdowns. Also, user functions may include directly raising or adjusting orders to equitize cash as well as raising or adjusting FX trades to match index benchmark rates. User functions may also include an ability to equitize income due but not received (T+1 and T+2).

Cash Components may include: Balancing Cash, Equitized/Unequitized (e.g., MM, T-Bills, etc.) Cash, Subs/Reds or Create/Redeems, Collateral, Settlement Date View, Open Orders (projected), Non-Settled Trades (projected), Corporate Events (projected) (e.g., Acquisition cash, Dividends, etc.), Unrealized Gain/Loss (projected) and Hedge Share Classes.

FIG. 1 illustrates equitizing cash where FX trading matches the index. As shown in FIG. 1, cash may be represented by 110, 112, and 114. Projected Cash (Index Based) 110 represents projected cash—index based, which may include corporate action cash (e.g., mergers acquisitions, etc.) and dividends. Projected Cash (Books Based) 112 may represent projected cash—books based, which may include open orders, unrealized gain and/or loss, and settling trades. Actual Cash 114 may represent actual cash which may include balancing cash, collateral, subs/reds or create/redeem. Input from cash represented by 110, 112, 114 may be received by an Optimizer 120. Other inputs may include current holdings, index holdings, etc. Optimizer 120 may then generate Equity Trade (MOC) 130, Future/Equity Trade (MOO/MOC) 132, Exchange Trade Fund (ETF) 134 and London FIX FX based on Open orders at 136. MOC represents market on close and MOO represents market on open. Exchange Trade Fund (ETF) represents marketable security that tracks an index, commodity, bond, index fund, etc. The price may change throughout the day. Foreign Exchange fixing may refer to a daily monetary exchange rate fixed by a bank of each country.

Optimizer 120 may also apply a priority when generating an output. For example, depending on size of incoming cash (or other factor), Optimizer 120 may determine a corresponding action, as represented by 130, 132 and 134. For example, based on the cash amount, Optimizer 120 may determine to purchase future equity trades, as shown by 132 or proceed with ETF 134.

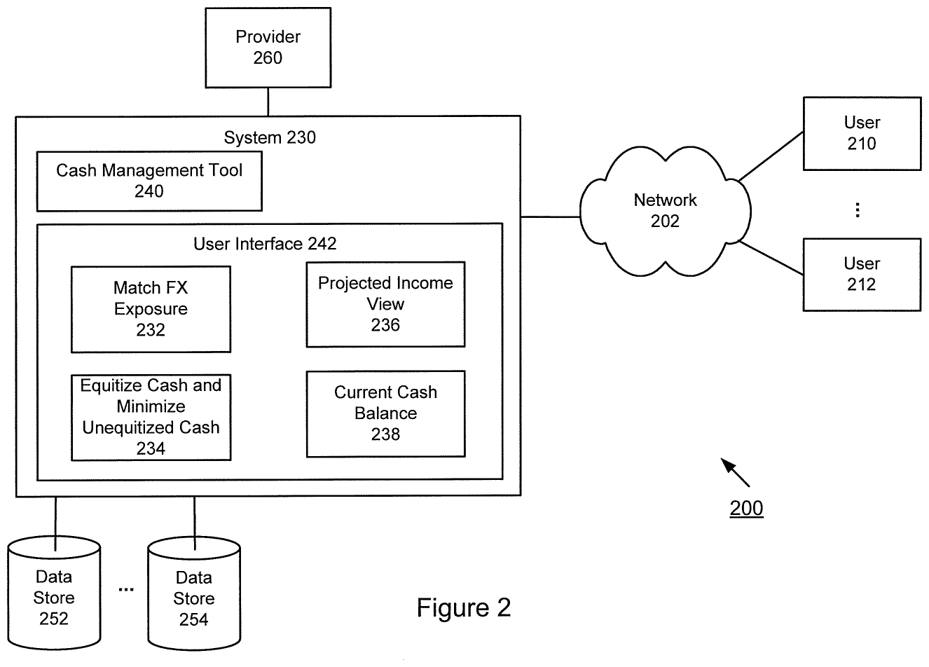

FIG. 2 illustrates a schematic diagram of a system that implements a Cash Management System, according to an exemplary embodiment. As illustrated in FIG. 2, System 230 may execute a Cash Management Tool 240. System 230 may communicate with various computing devices used by users 210, 212 via Network 202. Users may represent portfolio managers, investment managers and analysts, for example. Computing devices may include computers, laptops, workstations, kiosks, terminals, tablets, mobile devices, mobile phones, smart devices, etc. Computing devices may also have an application installed that is associated with Cash Management Tool 240.

System 230 may execute Cash Management Tool 240 and User Interface 244. Cash Management Tool 240 may include various computing components and processors. User Interface 244 may provide various modules and functions, represented by Match FX Exposure 232, Equitize Cash and Minimize Unequitized Cash 234, Project Income View 236 and Current Cash Balance 238. These modules are exemplary and illustrative, Cash Management Tool 240 may interact with additional modules, a combination of the modules described and/or less modules than illustrated. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. Other architectures may be realized.

System 230 may be communicatively coupled to data storage devices represented by Data stores 252, 254. The cash management features described herein may be provided by System 230 and/or a third party provider, represented by 260, where Provider 260 may operate with System 230.

The system 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 is depicted, it should be appreciated that other connections and relationships are possible. The system 200 described below may be used to implement the various methods herein, by way of example. Various elements of the system 200 may be referenced in explaining the exemplary methods described herein.

Network 202 may be a wireless network, a wired network or any combination of wireless network and wired network. Network 202 may utilize one or more protocols of one or more network elements to which it is communicatively coupled. Although Network 202 is depicted as one network for simplicity, it should be appreciated that according to one or more embodiments, Network 202 may comprise a plurality of interconnected networks, such as, for example, a service provider network, the Internet, a cellular network, corporate networks, or even home networks, or any of the types of networks mentioned above. Data may be transmitted and received via Network 202 utilizing a standard networking protocol or a standard telecommunications protocol.

System 230 may be communicatively coupled to Data Stores 252, 254 as well as remote storages. These storage components may include any suitable data structure to maintain the information and allow access and retrieval of the information. For example, the storage components may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein. The storage may be local, remote, or a combination. Communications with the storage components may be over a network, such as Network 202, or communications may involve a direct connection between the various storage components and System 230, as depicted in FIG. 2. The storage components may also represent cloud or other network based storage.

An embodiment of the present invention is directed to effectively managing cash for any market-cap index based strategy across multiple product channels, e.g., ETFs, UCITS, Commingled Funds, and SMAs. A primary investment goal for index tracking strategy is to track the index closely and achieve low and optimized tracking error between portfolio and index.

An embodiment of the present invention is directed to addressing various key deficiencies in the existing cash management process, which may include: (1) Match FX exposure of index in the portfolio to match the London close on T basis; (2) Ability to equitize cash and minimize the unequitized cash; (3) Projected Income view and (4) Show breakdown of current cash balance.

Match FX Exposure 232 may match FX exposure of index in the portfolio to match the London close on T basis. For example, index providers may make daily changes to an index (e.g., including the rebalance changes) at start of the day. Most index providers close their positions based on the spot rate determined at London close (e.g., WM/Reuters Closing Spot Rate). Index tracking funds generally require the same methodology to avoid tracking error due to currency movements.

According to an embodiment of the present invention, once portfolio managers submit equity and/or fixed income trades on T−1 to match the open of the index on T, the cash management tool provides an ability to view their open orders and calculate the currencies they have to buy or sell to offset the physical trades and match the currency exposure to the index. The cash management tool may also provide an ability to submit the FX orders based on the estimates for London close 4 PM execution, or other closing time frame.

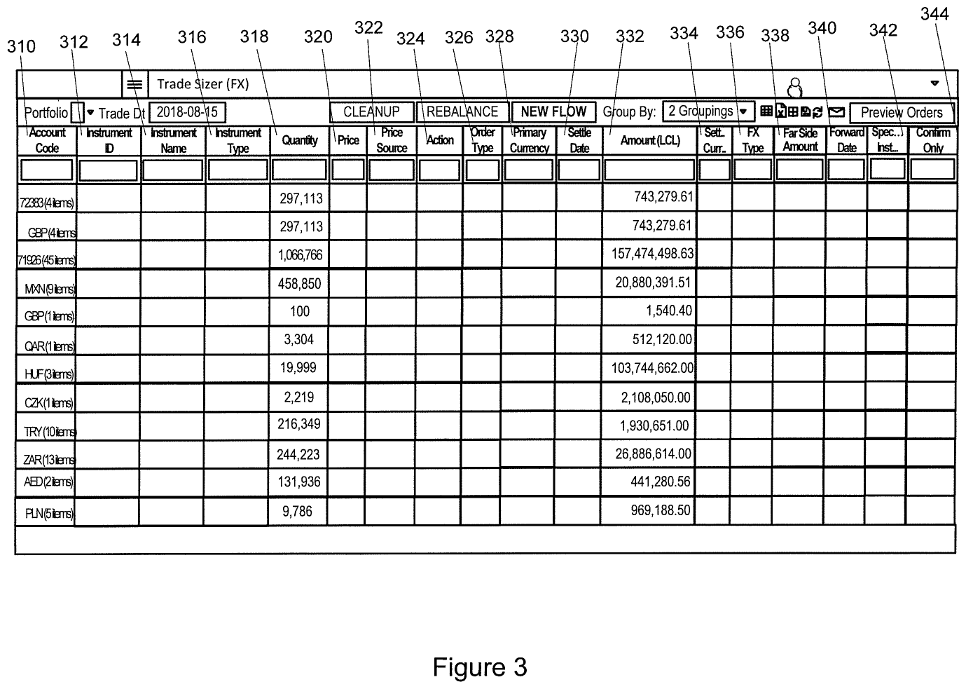

FIG. 3 illustrates an exemplary interactive interface of an Open Orders View, according to an embodiment of the present invention. FIG. 3 provides open orders information for a Portfolio and Trade Date. More specifically, FIG. 3 illustrates Account Code 310, Instrument Identifier 312, Instrument Name 314, Instrument Type 316, Quantity 318, Price 320, Price Source 322, Action 324, Order Type 326, Primary Currency 328, Settle Date 330, Amount 332, Settlement Currency 334, FX Type 336, Far Side Amount 338, Forward Date 340, Special Instructions 342 and Confirm Only 344. FIG. 3 is exemplary; other details may be provided as well.

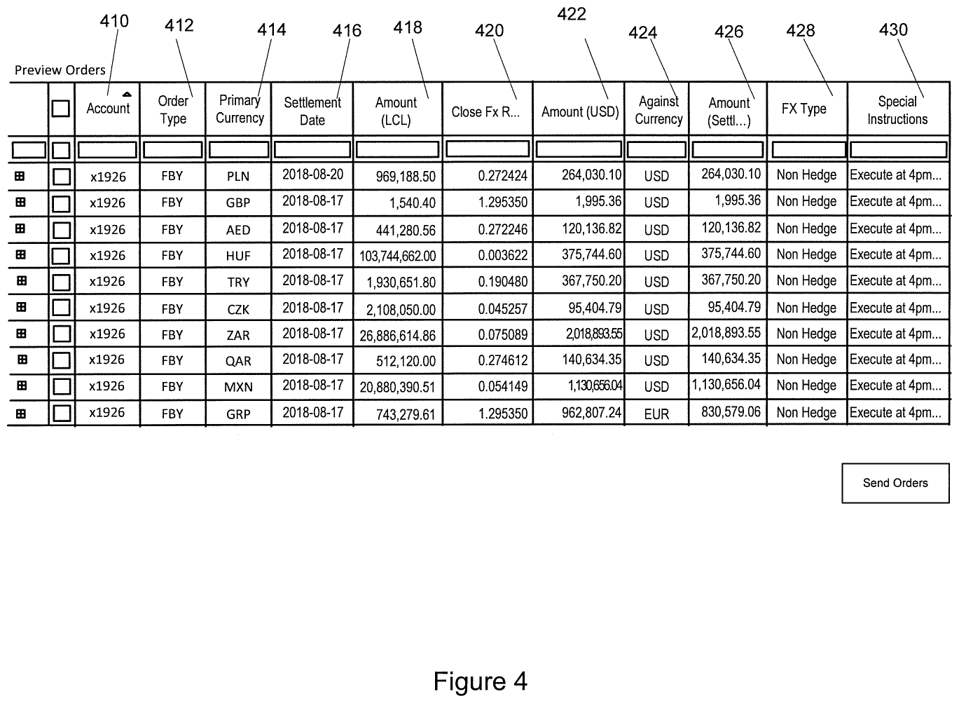

FIG. 4 illustrates an exemplary interactive interface of a FX Orders Preview, according to an embodiment of the present invention. FIG. 4 illustrates Preview Orders including Account 410, Order Type 412, Primary Currency 414, Settlement Date 416, Amount 418, Close FX 420, Amount 422, Against Currency 424, Amount (Settle) 426, FX Type 428, and Special Instructions 430.

Equitize Cash and Minimize Unequitized Cash 234 provides an ability to equitize cash and minimize the unequitized cash.

An objective of the index tracking investment model is to minimize the unequitized cash. This may involve portfolio managers to invest most of the cash in the investment vehicles that gives exposure to the index. Usual investment vehicles matching the exposure to the index are ETFs (e.g., ISHARE MSCI World) and Futures (e.g., MSCI EAFE future). For example, in a world account, MSCI may value currency at 4 pm London time and stock in the world index in another region may not trade until 4 pm U.S. time. In this example, an embodiment of the present invention may perform a currency trade before the equities are actually traded.

According to an embodiment of the present invention, the cash management tool provides an ability to maintain the baskets of futures/ETFs per portfolio (e.g., tracking the index). Given the available cash in the portfolio, the cash management tool may run algorithms to suggest which is the best basket to buy and how many baskets should be purchased to minimize the unequitized cash and increase the equitization. This further allows portfolio managers to directly submit these orders for execution to trading system.

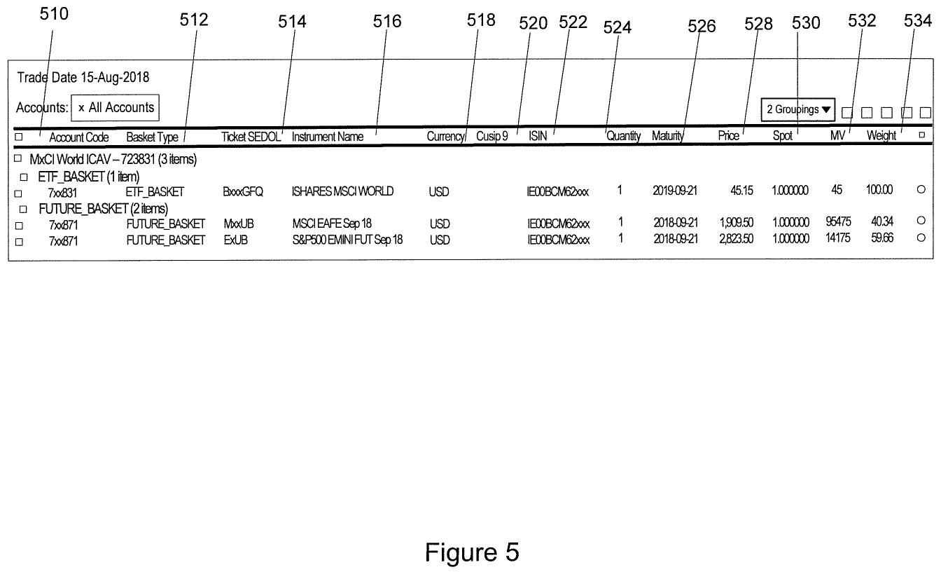

FIG. 5 illustrates an exemplary interactive interface of an ETF/Future Basket View, according to an embodiment of the present invention. FIG. 5 illustrates Account Code 510, Basket Type 512, Ticket 514, Instrument Name 516, Currency 518, CUSIP 520, ISIN 522, Quantity 524, Maturity 526, Price 528, Spot 530, MV 532, and Weight 534. CUSIP (Committee on Uniform Security Identification Procedures) and ISIN (International Securities Identification Number) represent standard codes issued to identify a security.

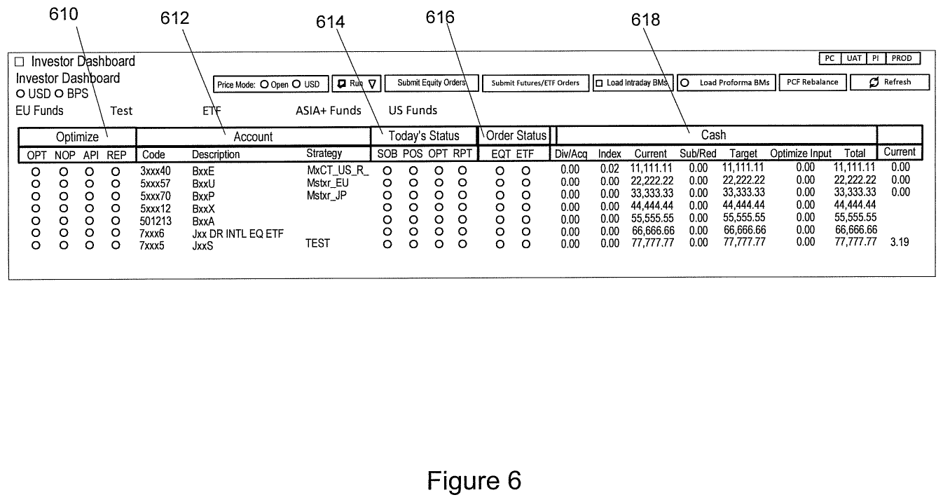

FIG. 6 illustrates an exemplary interactive interface of an Optimization View, according to an embodiment of the present invention. FIG. 6 illustrates an Investor Dashboard. FIG. 6 illustrates sections directed to Optimize 610, Account 612, Today's Status 614, Order Status 616 and Cash 618. Optimize 610 further illustrates OPT, NOP, API and REP. OPT represents a setting that instructs the system to use the Optimizer in client-server mode to calculate the trades. NOP represents a setting that instructs the system to not use the Optimizer but rather a heuristics-based model to generate trades. API represents a setting that instructs the system to use the Optimizer API to generate trades. REP represents a setting that uses a replication approach to generate trades in same weights as the underlying fund. Account 612 further details Code, Description and Strategy. Today's Status 614 provides SOB (Start of Business status), POS (Status of refreshing latest Position), OPT (Status of Optimizer run), RPT (Status of Risk Report). Order Status 616 may include EQT and ETF indicating the status of orders. EQT shows the status of raising the Equities trades while ETF shows the status of equitizing using Futures and ETFs. Cash 618 includes Dividends/Acquisitions, Index, Current, Sub/Red, Target Optimize Input, Total and Current.

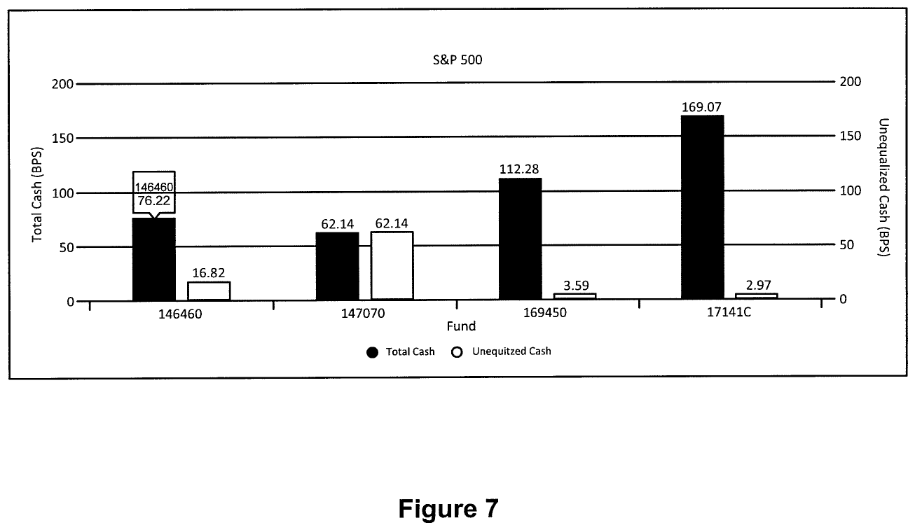

FIG. 7 illustrates an exemplary interactive interface of an Unequitized Cash View, according to an embodiment of the present invention. FIG. 7 illustrates a cash view for S&P 500. For each fund, a comparison of total cash and unequitized cash is shown.

Project Income View 236 provides an enhanced projected income view. Index providers reinvest dividends and other cash received from corporate actions on ex-Date. To effectively manage cash equitization, portfolio managers may require insight into future expected cash to match their portfolio benchmark returns.

According to an embodiment of the present invention, the cash management tool may provide an interactive user interface, e.g., a single dashboard, to the users to view their income due not received on T+2 and beyond. This provides a cash ladder type view of the expected income. In addition, the user interface projects the income fund may get due to corporate actions, such as mergers, acquisitions and dividends going ex on T+1/T+2.

Projected Cash may be sourced from various different sources. For example, projected cash may include corporate actions based cash, open orders, unrealized gain or loss, and/or accounting based income/expenses.

For corporate actions based cash, an embodiment of the present invention may connect to various index providers (e.g., Morningstar, MSCI, S&P, Russell) to pull corporate actions and project the cash expected to be receive due to corporate actions.

For Open Orders, this may refer to projected cash due to the trades PMs have submitted, estimates the money in/out due to trading.

For unrealized gain/loss, this may refer to unrealized gain/loss due to hedges share classes of the funds.

For accounting based income/expenses, these income/expenses may be due but not received/paid. This cash component may refer to any income or expenses available in the accounting books, such as dividends/fees with the future pay date.

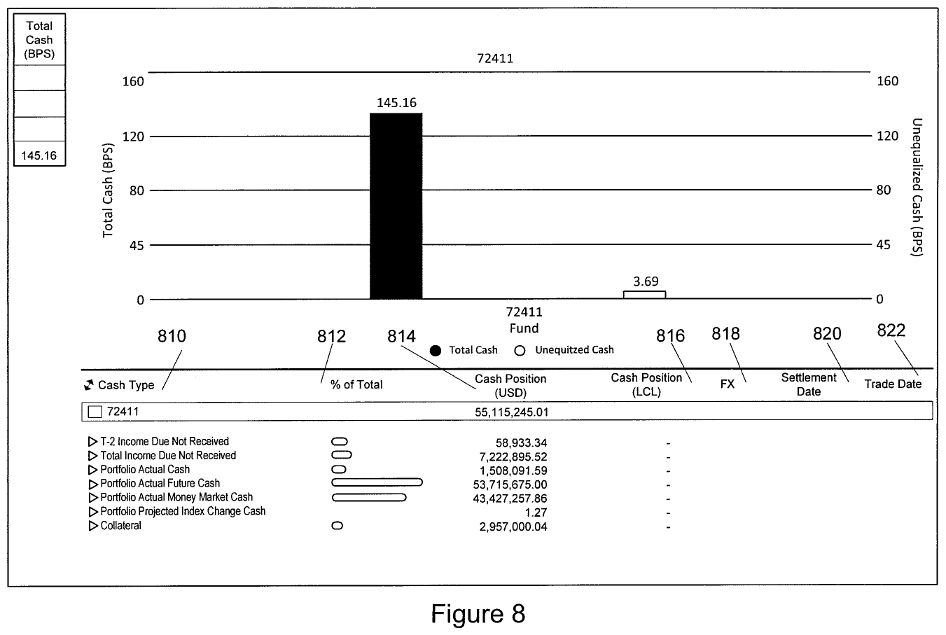

FIG. 8 illustrates an exemplary interactive interface of a Projected Income View, according to an embodiment of the present invention. FIG. 8 illustrates total cash and unequitized cash for a specific fund. FIG. 8 further details Cash Type 810, Percentage of Total 812, Cash Position 814, Cash Position 816, FX 818, Settlement Date 820 and Trade Date 822.

Current Cash Balance 238 provides a breakdown of current cash balance. An embodiment of the present invention recognizes a problem area is to show available cash balance in different investment vehicles so that portfolio managers may see what can be easily liquidated and then invest in the physicals.

According to an embodiment of the present invention, the cash management tool provides an ability to show a breakdown of available portfolio cash invested in different investment vehicles. Portfolio managers may quickly see what can be easily liquidated (e.g., short-term, T-Bills, etc.) and then invested in equities and bonds.

Cash may be sourced from different sources and made available to the portfolio managers via an interactive user interface, e.g., a single dashboard. Cash may be constructed from various components.

For example, actual cash may refer to available cash from accounting system; short-term/Money Market (e.g., any cash invested in short term that can be liquidated immediately and settles T+1); Non-Settle trades (e.g., any trades which are done but not settled yet); collateral (e.g., any collateral posted in the account can be invested); Subs/Reds (e.g., any client subs/reds); and collateral.

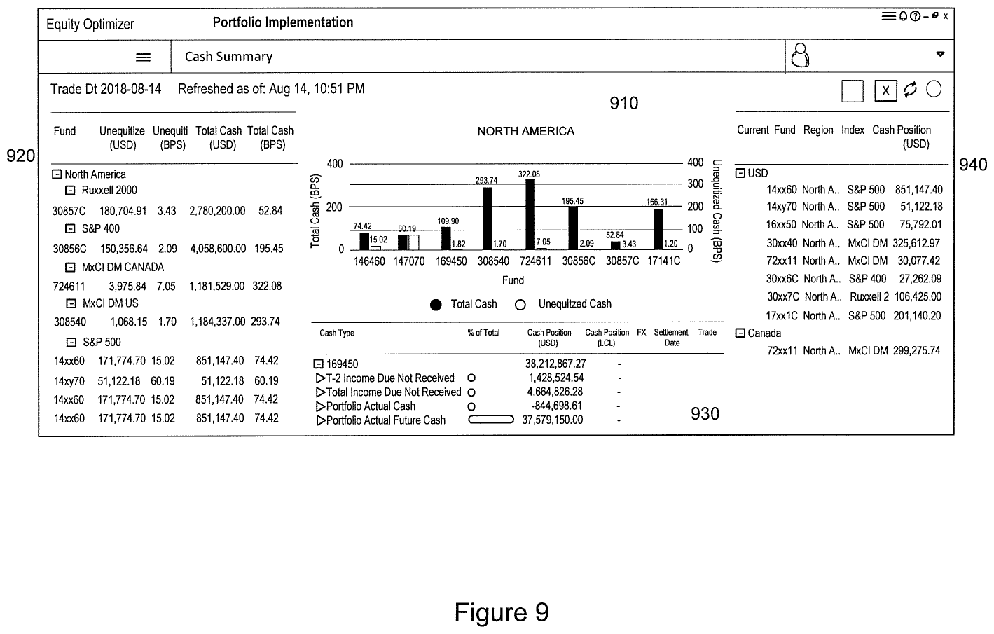

FIG. 9 illustrates an exemplary interactive interface of a Cash View, according to an embodiment of the present invention. FIG. 9 provides a detailed cash summary for a trade date. In this example, total cash for a specific region is shown, e.g., North America, in a graphical format at 910. Fund details are shown at sections 920, 930 and 940. Section 920 provides fund details including unequitized (USD) and (BPS) and total cash (USD) and (BPS). Section 930 provides cash details including cash type, percentage of total, cash position (USD) and (LCL), FX, settlement date and trade. Section 940 provides current fund details including region, index and cash position.

Other embodiments, uses, and advantages of the invention will be apparent to those skilled in the art from consideration of the specification and practice of the invention disclosed herein. The specification and examples should be considered exemplary only, and the scope of the invention is accordingly not intended to be limited thereby.

While the exemplary embodiments described herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Data and information maintained by a Processor may be stored and cataloged in a Database which may comprise or interface with a searchable database. The database may comprise, include or interface to a relational database. Other databases, such as a query format database, a Standard Query Language (SQL) format database, a storage area network (SAN), or another similar data storage device, query format, platform or resource may be used. The database may comprise a single database or a collection of databases, dedicated or otherwise. In one embodiment, the database may store or cooperate with other databases to store the various data and information described herein. In some embodiments, the database may comprise a file management system, program or application for storing and maintaining data and information used or generated by the various features and functions of the systems and methods described herein. In some embodiments, the database may store, maintain and permit access to participant information, transaction information, account information, and general information used to process transactions as described herein. In some embodiments, the database is connected directly to the Processor, which, in some embodiments, it is accessible through a network, such as a communication network, for example.

Communications network may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection.

Communications network may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 107 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network may comprise a satellite communications network, such as a direct broadcast communication system (DBS) having the requisite number of dishes, satellites and transmitter/receiver boxes, for example. Communications network may also comprise a telephone communications network, such as the Public Switched Telephone Network (PSTN). In another embodiment, communication network may comprise a Personal Branch Exchange (PBX), which may further connect to the PSTN.

In some embodiments, the processor may include any terminal (e.g., a typical personal computer system, telephone, personal digital assistant (PDA) or other like device) whereby a user may interact with a network, such as communications network, for example, that is responsible for transmitting and delivering data and information used by the various systems and methods described herein. The processor may include, for instance, a personal or laptop computer, a telephone, or PDA. The processor may include a microprocessor, a microcontroller or other general or special purpose device operating under programmed control. The processor may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. The processor may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). The processor may also include a network-enabled appliance, a browser-equipped or other network-enabled cellular telephone, or another TCP/IP client or other device.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The embodiments of the present inventions are not to be limited in scope by the specific embodiments described herein. For example, although many of the embodiments disclosed herein have been described with reference to identifying events and communicating notification, the principles herein are equally applicable to other applications. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

1. An automated computer implemented system that implements an automated cash management tool to manage cash for market cap index, the system comprises:
a memory component;
an interactive interface that receives one or more user inputs; and
an optimizer processor, coupled to the memory component and the interactive interface, the optimizer processor configured to perform the steps comprising:
receiving, via an electronic input, a first projected cash that is indexed based; a second projected cash that is books-based and an actual cash measure for a portfolio;
identifying equity and fixed income trade at time T−1 for the portfolio;
providing, via the interactive interface, one or more open orders for the portfolio; and
calculating, responsive to the open orders, one or more currencies to purchase or sell to substantially match a currency exposure of an index in the portfolio at time T to minimize tracking error between the portfolio and the index.

2. The system of claim 1, wherein FX orders are submitted, via the interactive interface, based on one or more estimates for London close execution.

3. The system of claim 1, wherein the optimizer processor is further configured to perform the step of:
maintaining, via the interactive interface, one or more baskets of futures and Exchange Trade Funds for the portfolio.

4. The system of claim 3, wherein the optimizer processor is further configured to perform the step of:
executing an algorithm to identify an optimal basket from the one or more baskets to purchase to minimize unequitized cash and increase equitization.

5. The system of claim 4, wherein the optimizer processor is further configured to perform the step of:
enabling direct purchase of order associated with the optimal basket for execution.

6. The system of claim 1, wherein the optimizer processor is further configured to perform the step of:
generating a projected cash amount from a plurality of sources comprising corporate actions based cash, open orders, unrealized gain and loss and accounting based income and expenses.

7. The system of claim 1, wherein the interactive interface provides a breakdown of available portfolio cash invested.

8. The system of claim 7, wherein the available portfolio cash invested comprises available cash from an accounting system, short-term money market, non-settle trades and collateral.

9. The system of claim 1, wherein the first projected cash is based at least partially on corporation actions.

10. The system of claim 1, wherein the second projected cash is based on open orders, unrealized gain and loss and settling trades.

11. An automated computer implemented method that implements an automated cash management tool to manage cash for market cap index, the method comprises the steps of:
receiving, via an electronic input, a first projected cash that is indexed based; a second projected cash that is books-based and an actual cash measure for a portfolio;
identifying, via an optimizer processor, equity and fixed income trade at time T−1 for the portfolio;
providing, via the interactive interface, one or more open orders; and
calculating one or more currencies to purchase or sell to substantially match a currency exposure of an index in the portfolio at time T to minimize tracking error between portfolio and index.

12. The method of claim 11, wherein FX orders are submitted, via the interactive interface, based on one or more estimates for London close execution.

13. The method of claim 11, further comprising the step of:
maintaining, via the interactive interface, one or more baskets of futures and Exchange Trade Funds for the portfolio.

14. The method of claim 13, further comprising the step of:
executing an algorithm to identify an optimal basket from the one or more baskets to purchase to minimize unequitized cash and increase equitization.

15. The method of claim 14, further comprising the step of:
enabling direct purchase of order associated with the optimal basket for execution.

16. The method of claim 11, further comprising the step of:
generating a projected cash amount from a plurality of sources comprising corporate actions based cash, open orders, unrealized gain and loss and accounting based income and expenses.

17. The method of claim 11, wherein the interactive interface provides a breakdown of available portfolio cash invested.

18. The method of claim 17, wherein the available portfolio cash invested comprises available cash from an accounting system, short-term money market, non-settle trades and collateral.

19. The method of claim 11, wherein the first projected cash is based at least partially on corporation actions.

20. The method of claim 11, wherein the second projected cash is based on open orders, unrealized gain and loss and settling trades.
